(19) United States
(12) Patent Application Publication
(10) Pub. No.: US 2010/0140409 A1
(43) Pub. Date: Jun. 10, 2010

(54) SYSTEM FOR ACCOMMODATING AT LEAST ONE OBJECT IN A CABIN OF A VEHICLE

(75) Inventor: Nils Poerner, Stade (DE)

Correspondence Address: LERNER, DAVID, LITTENBERG,;KRUMHOLZ & MENTLIK, 600 SOUTH AVENUE WEST, WESTFIELD, NJ, 07090, US

(73) Assignee: AIRBUS OPERATIONS GMBH, Hamburg (DE)

(21) Appl. No.: 12/618,964

(22) Filed: Nov. 16, 2009

Related U.S. Application Data
(60) Provisional application No. 61/199,904, filed on Nov. 21, 2008.

(30) Foreign Application Priority Data
Nov. 21, 2008 (DE) 10 2008 058 425.8

(51) Int. Cl. B64C 99/00; G06K 7/08

(52) U.S. Cl. 244/131; 235/451

(57) ABSTRACT

A system for accommodating at least one object in a cabin of a vehicle exhibits at least one first connecting means, at least one second connecting means and at least one latching device, wherein the first connecting means is positioned in the cabin of the vehicle, and the second connecting means is positioned on the object, the first connecting means and the second connecting means establish a connection in an accommodating position of the object, and the latching device latches the object in the accommodating position. This makes it possible to replace conventional stowage compartments with a weight-saving system, which may accommodate correspondingly prepared luggage items or other objects in a vehicle cabin.

### CROSS-REFERENCE TO RELATED APPLICATIONS

This application claims the benefit of the filing date of U.S. Provisional Patent Application No. 61/199,904 filed Nov. 21, 2008, the disclosure of which application is hereby incorporated herein by reference.

### BACKGROUND OF THE INVENTION

The invention relates to a system for accommodating at least one object in a cabin of a vehicle. The invention further relates to the use of such a system, an item of luggage, as well as an aircraft with at least one such system.

Vehicles, for example commercial aircraft, today generally have numerous stowage compartments in the cabin, in which items of luggage of passengers may be accommodated. The stowage compartments are located predominantly over the passenger seats on the ceiling of the cabin. Usually, such stowage compartments are joined with structural components of the aircraft by retaining brackets and connecting rods. Such stowage compartments have several disadvantages: On the one hand, the required stability is associated with a relatively high weight of the stowage compartments. It is essential that the stowage compartments be able to safety accommodate accompanying carry-on luggage, and that irregularities during the drive or flight neither damage a stowage compartment, nor cause an item of luggage to spontaneously exit the stowage compartment. In addition, the boarding time may increase if passengers attempt to stow unsuitable or non-standardized carry-on luggage in the stowage compartments. In addition, it is not possible to clearly identify carry-on luggage items and allocate them to a flight passenger, since other than handwritten labels, hardly any identification functions are available for this purpose. Finally, another disadvantage is that the operator of the corresponding aircraft must maintain and occasionally also replace the stowage compartments.

German Patent No. DE 4425869A1, U.S. Pat. No. 5,383,628 A and German Patent No. DE 9214592 U1 show lowerable overhead stowage compartments, which completely envelop the items of luggage to be stowed, and each exhibit a considerable empty-weight.

One object of the invention may be to propose a device or system for accommodating objects in a cabin of a vehicle, in which the lowest possible additional weight comes about for the cabin, while items of luggage or other objects may likewise be safely accommodated. The object may be achieved by a system according to the features in independent claim 1. Advantageous embodiments may be gleaned from the following dependent claims.

### BRIEF SUMMARY OF THE INVENTION

In a first aspect of the invention, the system for accommodating at least one object in a cabin of a vehicle may comprise at least one first connecting means, at least one second connecting means, and at least one latching device. The first and second connecting means are configured to establish a mechanical connection between them. The first connecting means is thereby positioned in the cabin of the vehicle, while the second connecting means may be situated on the object to be accommodated in the cabin. The two connecting means may preferably be joined together in an accommodating position of the object. What this means is that an object, for example an item of luggage, must already have been prepared by the second connecting means attached thereto to be accommodated in a predetermined position within the cabin of the vehicle. This second connecting means may then establish a connection with the first connecting means, which is situated inside the cabin, preferably fixed in place.

The invention is not limited to specific types of connections between the first and second connecting means; any positive, non-positive, or other types of connections may be fabricated with the two connecting means. One relatively simple variant might involve hooking a connecting means into another connecting means, for example.

If the object is in its stowage position, and the first connecting means is secured to the second connecting means, operational safety reasons dictate that this stowage position or accommodating position of the object be secured. This is done by means of a latching device, which secures the object in its accommodation position. Any conceivable latching options are also possible as the latching device, to possibly include positive or non-positive connections as well. For example, the simplest conceivable option is a catch and pawl connection, which is easy to engage and then disengage again in like manner.

Such a configuration of the system according to the invention may make it possible to do without classic stowage compartments. Rather, the structural area usually occupied by classic stowage compartments is empty, and only exhibits initial connecting means set up to hold objects to be accommodated. This enables a considerable savings in weight, since it eliminates the need for complicated designs for completely closeable stowage compartments provided with flaps.

In addition, the system according to the invention may in the future bring about a scenario under which preferably completely standardized pieces of carryon luggage already provided with second connecting means may be used for taking carryon luggage into the cabin of a vehicle, in particular an aircraft, simplifying the configuration of the system according to the invention, while generally yielding a significant savings in weight for the aircraft and tangibly improving the loading and unloading process inside the cabin.

The system according to the invention may be used in any type of motor vehicle, and is not limited to the aircraft shown as an example. Its use may be conceivable in land-bound motor vehicles as well as watercraft, for example ships.

In an advantageous further development of the system according to the invention, the first connecting means is set up to establish a connection with several second connecting means. For example, this could be accomplished by having the first connecting means exhibit a lengthwise extension, and a second connecting means correspondingly designed as a receptacle possessing a suitable cross-sectional profile. The first connecting means could take the form of a rod or rail, for example, which the second connecting means could hook into. It is relatively easy to secure rods or rails along the cabin of the vehicle, since continuous first connecting means potentially require fewer attachment means than separate first connecting means.

On the other hand, however, it might also be advantageous to set up the first connecting means solely to establish a connection with an individual second connecting means. This could economize on additional weight, for example by arranging the first connecting means as separate hooks along an extension direction of the cabin. For example, these separate hooks could be hooked into by second connecting means, which may again be designed as lengthwise rods or rails, for example, which combined with the first connecting means could exhibit a lower weight than continuous first connecting means with second, hooking connecting means. The configuration of the first and second connecting means is not confined to the mentioned hooks, rods or rails in this advantageous further development either.

It is especially preferred that the latching device be positioned in the cabin of the vehicle, and exhibit at least a spring-mounted pawl, which may snap into a catch located on the object. This could make it possible to position the object to be accommodated in the cabin on the first connecting means using the second connecting means, and swivel, fold or otherwise move it into an accommodation position. For example, the object could exhibit several hook-like second connecting means, which engage a first connecting means designed as a rod in the cabin. If the object is hooked into the rod from an aisle in the cabin, and upwardly swiveled around the longitudinal axis of the rod toward the cabin ceiling, for example, a catch located on the object could engage a latching device, in which a spring-mounted pawl is deflected outwardly and latches into the inserted catch. As a consequence, the object is automatically held in the accommodating position during insertion by means of the connection established between the first and second connecting means, and additionally latched by the latching device. This ensures that the objects may be safely introduced into the cabin in a very easy manner. Activating a corresponding actuating element makes it possible to release the latched pawl again, and the object may be removed from the cabin once more.

For example, the latching device could be realized as a kind of conventional automobile seatbelt lock. The catch could additionally be set up to be locked by remote control with an electrical or mechanical device, or manually, so as to prevent a removal of the objects and potential endangerment of passengers in critical phases of the vehicle.

In another aspect of the invention, the achieved, defined positions of the objects or luggage items in the cabin make it possible to position electronic readers in the cabin in such a way that preferably all objects introduced into the cabin may be clearly identified and assigned to checked-in passengers. This is accomplished, for example, by positioning RFID readers in the cabin in such a way that they may read RFID tags on the objects, when the latter are in the respective accommodation position. For example, an RFID reader could be situated directly on the latching device, wherein the corresponding RFID tag of the object is preferably located next to the catch. With the catch latched in the latching device, the RFID tag and RFID reader consequently approach each other so closely as to enable a reading process.

The objects or luggage items are preferably furnished with irreversible RFID tags, which are programmed with a unique identification number, for example. These unique identification numbers could also be stored in already existing databases with passenger information, and correlated with personal data, so that, for example while boarding the aircraft and loading the objects in the accommodating position on board the aircraft, a determination may be made as to which carryon luggage items are already on board, and which carryon luggage items and associated passengers are still missing.

In addition, another aspect of the invention makes it possible to equip the system with an electrical interface, so that objects situated in the accommodation position may enter into an electrical connection with corresponding flight systems, for example. For example, this could lead to a situation in which electronic devices located inside the object or luggage item may be charged or supplied with power. As a result, a passenger inside the cabin could have a luggage item in an accommodation position over his seat that integrates a playback device for music or the like, which is supplied with power by the aircraft, and could be used by the passenger using a headphone jack and possibly a remote control.

It is also conceivable to transmit data about the structural composition or operational safety of the object by way of the interface or an additional interface. For example, an accelerometer with a logging function could collect information about whether the suitcase has experienced accelerations that exceed specific, set values, or whether an expiration or inspection date for technical monitoring is pending or has even been exceeded.

In addition, the aesthetics could be improved by having the system further exhibit covering devices that cover introduced objects and unoccupied accommodation spaces. These covering devices could be designed like a roller shutter, which may be moved from a retracted position to a deployed, covering position, thereby imparting a uniform appearance to the entire cabin.

The object is further achieved by using a system according to the invention, a luggage item and an aircraft with a system according to the invention based on the features of the additional independent claims.

### BRIEF DESCRIPTION OF THE DRAWINGS

Additional features, advantages and possible applications of the present invention maybe gleaned from the following description of the exemplary embodiments and the figures. In this case, all described and/or depicted features constitute the object of the invention, whether taken separately or combined in any fashion, even irregardless of their composition in the individual claims or their back references. The same reference numbers in the figures stand for the same or similar objects.

FIG. 1 shows a system according to the invention, sectional side view.

FIG. 2 shows a luggage item according to the invention.

FIG. 3a+b show the process of introducing a luggage item according to the invention on the system according to the invention.

FIG. 4 shows a system according to the invention, sectional side view, with cover closed.

FIG. 5 shows an aircraft with a system according to the invention.

### DETAILED DESCRIPTION

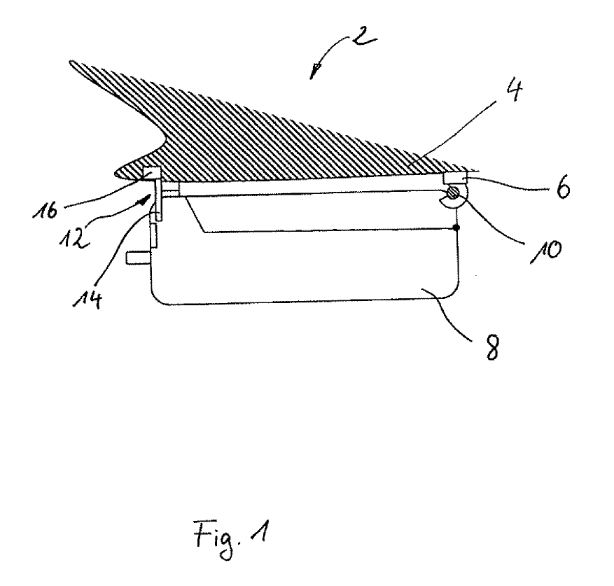

Shown on FIG. 1 is a system 2 according to the invention, which is accommodated in the cabin of a vehicle. Arranged on the cabin ceiling 4 is a first connecting means 6, which is here depicted as a hook or clamp, for example. Let it be stated here based on the sectional side view that a row of additional first connecting means 6 is located behind the first connecting means 6. An object here designed as a luggage item exhibits a second connecting means 10, which is joined with the first connecting means 6. The connection between the first connecting means 6 and the second connecting means 10 lies in the area of a rear edge of the object 8, so that this connection alone would be insufficient to completely hold the object 8 in its accommodation position. To be understood as the accommodation position is the one shown on FIG. 1, in which the object 8 is arranged as tightly as possible against the cabin ceiling 4. In order to sufficiently mount the object 8 on the cabin ceiling 4, use is made of a latching device 12 arranged on the cabin ceiling 4, in which a catch 14 may establish a connection with a pawl 16. The pawl 16 is secured permanently to the vehicle on the cabin ceiling 4, while the catch 14 is attached to the object 8.

The connection between the object 8 and cabin ceiling 4 via the system 2 must satisfy stringent requirements due to the exposed position over the passenger seats. Under all conceivable circumstances, it is to be ensured that the object 8 cannot spontaneously detach from the cabin ceiling 4 and fall on passengers below. This may be ensured by performing stringent tests on the first connecting means 6 and second connecting means 10, as well as on the latching device 12 with the catch 14 and pawl 16. For example, so-called 16 g tests are performed, in which loaded objects 8 are secured using a system 2 according to the invention, and exposed to 16 times gravitational acceleration. The object 8 cannot be spontaneously detached or torn off in the process.

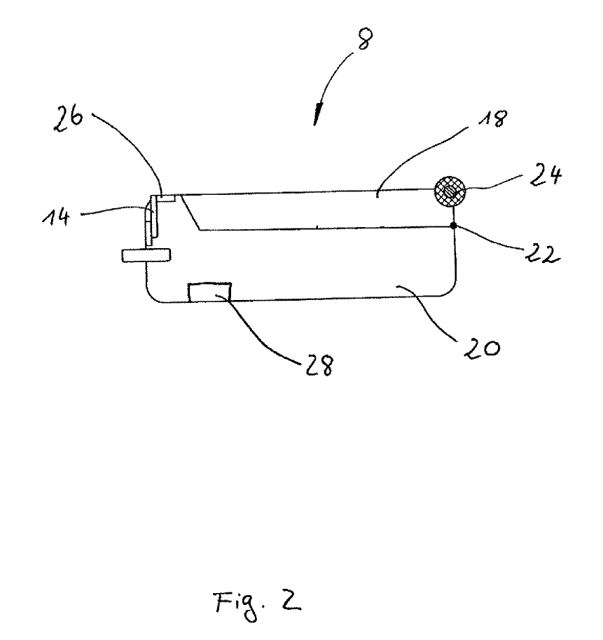

FIG. 2 also shows an object 8 designed as a luggage item, which satisfies the usual requirements on carryon luggage. The object 8 consists of an upper shell 18 and lower shell 20, which are joined together by a hinge 22. The upper shell 18 has a roller pair 24 that may be used for easily transporting the object 8 when it is not in the accommodating position. The lower shell 20 is designed in such a way as to prevent the object 8 from opening when he object 8 is in an accommodating position with catch 14 latched. In the case at hand, this means specifically that the lower shell 20 covers the front edge of the upper shell 18 facing away from the rollers 24. This is advantageous, since intentional or accidental opening could cause the evacuation of contents in the object 8, wherein persons located below could potentially be hit be falling items and injured.

Further, the catch 14 is integrated into the object 8 in such a way that it may also be lowered into a corresponding recess of the object 8, so it does not get in the way when the object 8 is not in an accommodating position.

In addition, the object 8 could exhibit an electrical interface 26 for use in charging or supplying power to electronic devices located within the object 8. For example, it might be possible for the object 8 to incorporate an audio playback device 28 that could be used during a trip in the vehicle by the passenger preferably located underneath who owns the object 8 or luggage item. The playback device 28 could then be supplied with electrical power by an on board power supply via the electrical interface 26. The electrical interface 26 need not necessarily establish mechanical contact; it could also be advantageous to inductively transmit electrical power, so thereby avoiding contamination or damage in the case of frequently changing objects 8.

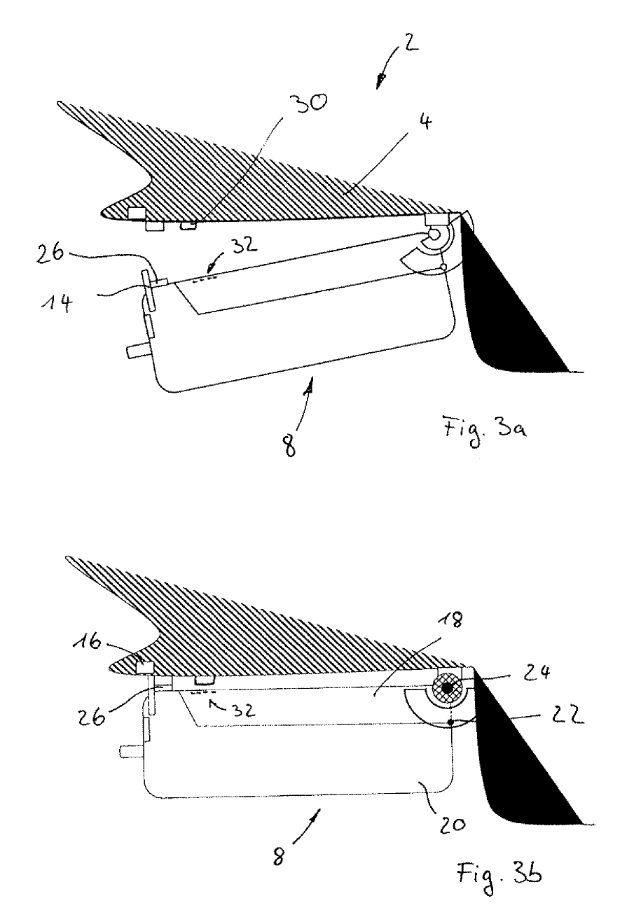

FIGS. 3a and 3b show the process of introducing and latching an object 8 on the system 2. The object 8 with the second connecting means 10 is hooked into the first connecting means 10 on FIG. 3a. The front end of the object 8 that exhibits the catch 14 is still clearly spaced apart from the pawl 16 or even from the cabin ceiling 4 itself. By turning the object 8 around the rotational axis lying essentially within the first connecting means 6, the catch 14 is made to approach the pawl 16, and latches there. This not only yields a latching action, but also establishes a connection with the interface 26.

In addition to an electrical connection via the interface 26, it is also conceivable that a reader 30 for an RFID tag 32 be integrated on the system 2 on the cabin ceiling 4, which may clearly identify an introduced object 8 and assign it to a passenger by way of a database or the like. It is especially advantageous for the RFID tag 32 to be integrated permanently in the suitcase, and exhibit a clear, individual number, which also clearly identifies the object 8. It is particularly advantageous to integrate the RFID tag 32 into the object 8 in such a way that it may only be detached again by destroying the object 8.

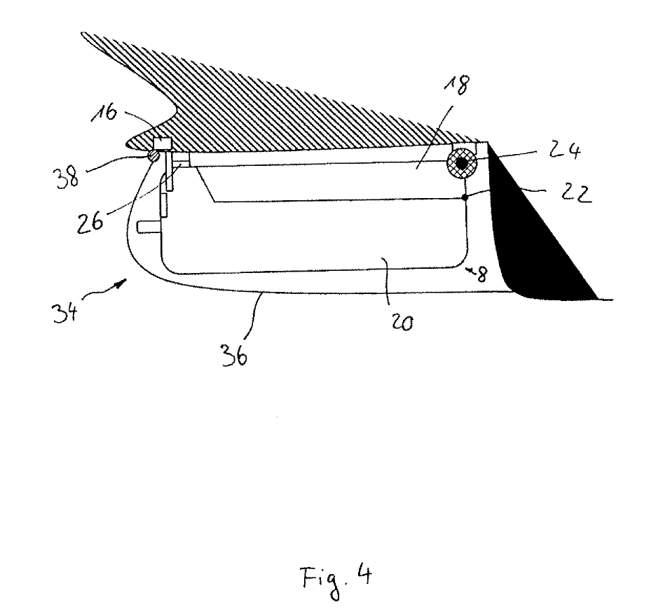

FIG. 4 finally depicts a covering device 34 consisting of a covering material 36 and a roller 38, for example, and may be brought to the accommodating position similarly to a roller shutter or Venetian blind over the introduced object 8, so as to produce a uniform appearance. This makes it possible to evaluate the visual appearance of the cabin f the vehicle, and create a uniform, quiet environment for the passengers.

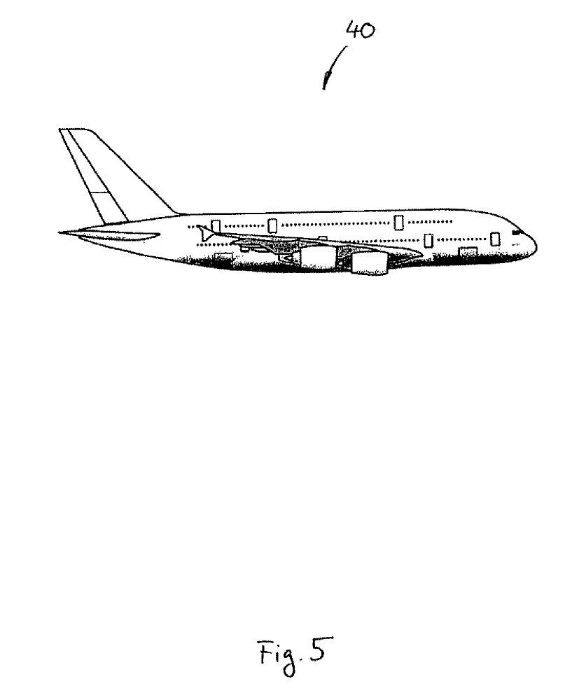

Finally, FIG. 5 shows an aircraft 40 that could be equipped with one or more systems according to the invention.

It is especially advantageous that the system according to the invention enables an economizing of additional weight that would have otherwise been caused by the stowage compartments. In addition, it renders unnecessary the maintenance work that would have been required owing to potentially damaged stowage compartments or stowage compartment lids.

In addition, let it be noted that “exhibiting” does not preclude any other elements or steps, and that “one” or “an” does not rule out a plurality. Let it further be noted that features described with reference to one of the above exemplary embodiments may also be used in combination with other features in other exemplary embodiments described above. The reference numbers in the claims must not be construed as a limitation.

### LIST OF REFERENCE NUMERALS

2 System
4 Cabin ceiling
6 First connecting means
8 Object
10 Second connecting means
12 Latching device
14 Catch
16 Pawl
18 Upper shell
20 Lower shell
22 Hinge
24 Wheel
26 Interface
28 Audio playback device
30 RFID reader
32 RFID tag
34 Covering device
36 Covering material
38 Roller
40 Aircraft

1. A system for accommodating at least one object in a cabin of a vehicle, comprising:
at least one first connecting means;
at least one second connecting means; and
at least one latching device;
wherein the first connecting means is positioned in the cabin of the vehicle, and the second connecting means is positioned on the object;
wherein the first connecting means and the second connecting means establish a connection in an accommodating position of the object; and
wherein the latching device latches the object in the accommodating position.

2. The system of claim 1, wherein the first connecting means is set up to establish a connection with several second connecting means.

3. The system of claim 1, wherein the first connecting means comprises a lengthwise extension, and a second connecting means correspondingly designed as a receptacle possesses a suitable cross-sectional profile.

4. A system of claim 1, wherein the first connecting means is set up to establish a connection with a second connecting means.

5. A system of claim 1, wherein the first connecting means is shaped like a hook or bracket.

6. A system of claim 1, wherein the latching device is positioned in the cabin of the vehicle, and exhibits at least one spring-mounted pawl, which pawl is adapted for latching into a catch located on the object, so that the latching device, once the object has reached the accommodating position, is automatically activated, and is releasable again by activating an actuating element for moving the pawl.

7. The system of claim 6, further comprising a device for locking the catch in a latched state.

8. The system of claim 1, wherein one or more RFID readers is positioned in the cabin of the vehicle for reading RFID tags arranged on the objects.

9. The system of claim 1, further comprising an electrical interface for electrically connecting the object and at least one electrical system permanently installed in the vehicle.

10. The system of claim 1, further comprising a covering device for covering objects or unoccupied accommodation spaces.

11. The system of claim 10, wherein the covering device comprises a covering means and a roller for holding the covering means.

12. An object comprising at least a second connecting means set up to be joined with at least one first connecting means and a latching device;
wherein the first connecting means is positioned in the cabin of a vehicle;
wherein the first connecting means and the second connecting means establish a connection in an accommodating position of the object; and
wherein the latching device latches the object in the accommodating position.

13. The object of claim 12, designed as a piece of luggage.

14. Use of a system of claim 1 in a vehicle.

15. An aircraft with at least one system for accommodating at least one object in a cabin of the aircraft, comprising:
at least one first connecting means;
at least one second connecting means; and
at least one latching device;
wherein the first connecting means is positioned in the cabin of the vehicle, and the second connecting means is positioned on the object;
wherein the first connecting means and the second connecting means establish a connection in an accommodating position of the object; and
wherein the latching device latches the object in the accommodating position.
